(19) United States
(12) Patent Application Publication
(10) Pub. No.: US 2006/0145486 A1
(43) Pub. Date: Jul. 6, 2006

(54) Metallic door security locking device

(76) Inventors: Victor J. Ponelis, Ft. Myers, FL (US); I. K. Steuart, Ft. Myers, FL (US)

Correspondence Address: Victor J. Ponelis, P.O. Box 7387, Ft. Myers, FL, 33911, US

(21) Appl. No.: 11/027,213

(22) Filed: Jan. 3, 2005

(51) Int. Cl. E05C 17/44

(52) U.S. Cl. 292/338

(57) ABSTRACT

To provide added security to the hinged edges of all residential and other doors.

A two piece device of metal or plastic and all combinations thereof, resembling hinge leaves (1)(12) that are intended to be attached to the door post and the hinged edge of all doors and where one of the pieces (1) is fitted with pin extensions (2) that interlock with slots or holes (11) in the mating piece (12) when the door is in the closed position. The locking pins (2) may be cylindrical or tapered and may be attached to the plate (1) by welding, forging or pressing. The locking pins (2) may be solid or fitted with rotating external sleeves (8) or internal rods which may be secured onto and into the locking pins (2) by all simple mechanical means. Each half of the device is attached to the door frame and the hinged edge of the door by two or more countersunk screws.

### BACKGROUND

1. Field of the Invention

This invention relates to automatic passive door locks that reinforce and increase the locking capacity of the hinged edge of all common rectangular doors used for human ingress and egress in any type of building or vehicle where security of access is important.

2. Description of Prior Art

Security of access and egress through doors has been of concern to security minded people for many years. It has long been realized that a securely locked and bolted door is still vulnerable to break-ins if the door hinges and frames are not of equal security. On many it is a simple method to drive out the hinge pins on the hinged side of the door. Prior art includes hinges which combine a fixed pin or stud secured to one leaf of the door hinge and which engage recesses in the other leaf of the hinge when the door is closed and the hinge leaves are brought flush together. Said pin or stud prevents the hinge leaves from being separated in an outward direction if the hinge pins are removed. Prior art also includes similar pin devices in a safe or vault door which engage recesses in the safe or vault door frame when said door is in the closed position.

### OBJECTS AND ADVANTAGES

1. Provide a door security device of suitable metals or plastics and all combinations thereof that is simple to fabricate and install.

2. Provide a door security device that can be economically produced and marketed.

3. Provide a door security device that can be retrofitted to any existing door.

4. Provide a door security device consisting of two flat pieces similar to hinge leaves but each being separated when the door is in the open position.

5. Provide a door security device of two separate pieces mesh and interlock when the door is in the closed position.

6. Provide a door security device of two pieces where one piece is attached into a recess in the door frame and the other piece is attached into a recess in the hinged edge of the door.

7. Provide a door security device where the female piece attached to the door frame is notched or drilled to receive one or more rigid pins.

8. Provide a door security device where the male piece attached to the door is fabricated with cylindrical or tapered pins protruding from and welded, forged or cast as part of the plate.

9. Provide a door security device where the cylindrical or tapered pins extending from the male piece are fitted with rolling sleeves which may be retained on said pins by all simple mechanical means.

10. Provide a door security device where the cylindrical or tapered pins extending from the male piece are drilled parallel to their center lines to receive rotating metal rods or pins which may be retained by all simple mechanical means.

### DRAWING FIGURES

The drawings depict different views of the Door Security Locking Device.

FIG. 1A shows a plan view of the male portion of the Door Security Locking Device.

FIG. 2A shows a side elevation of the rolling sleeve which is crimped to 2 the male portion of the Door Security Locking Device.

FIG. 3A shows a plan view of the female portion of the Door Security Locking Device.

FIG. 3B shows a side elevation of the female portion of the Door Security Locking Device.

### REFERENCE NUMERALS IN DRAWINGS

1 Base plate of male and female leaves or portions of the Door Security Locking Device.

2 Locking pin attached to the male portion or leaf of the Door Security Locking Device.

3 Welds attaching 2 the male locking pins to the male portion or leaf of the Door Security Locking Device.

4 Recessed groove for skirt of the rolling sleeve at the base of the male locking pin.

5 Counter sunk screw hole to attach leaves of the male and female portions of the Door Security Locking Device to the door and the door frame respectively.

7 Grooves in the male pins 2 to receive crimps 9 in the rollers 8 of the Door Security Locking Device.

8 Roller sleeves fitted to male pins 2.

9 Crimps in roller sleeves 8 which secure roller sleeves 8 to the male pins 2.

10 Skirt recessed into grooves 4 in male potion base plate 1.

11 Slots in female plate 12 which receive the roller covered male pins in the closed position.

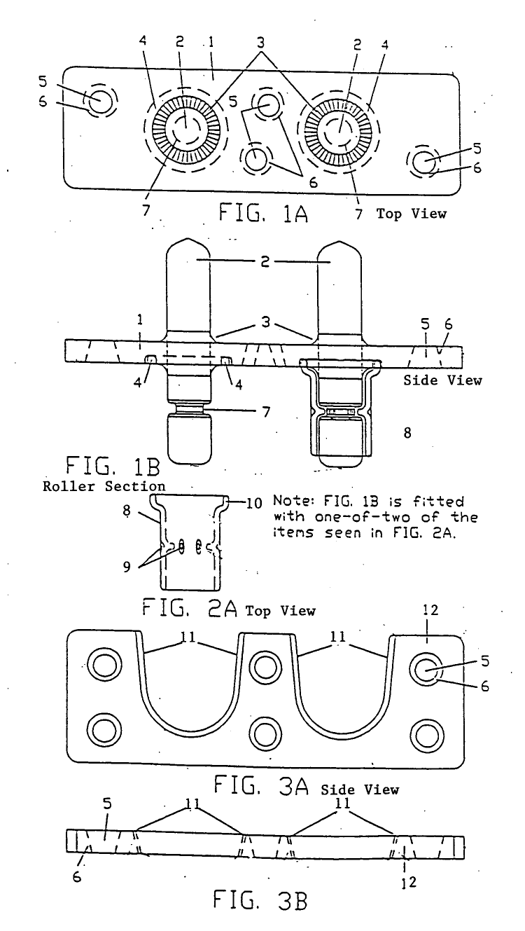

### DESCRIPTIONS AND OPERATIONS—FIGS. 1A TO 1B

FIG. 1A is a plan view of the male leaf (1) or portion of the Door Security Locking Device. The plan view shows two locking pins (2) with rolling sleeves (8) with retaining snap rings (4). Four countersunk screw holes (5) are shown.

FIG. 1B is an elevation of the male portion of the Door Security Locking Device showing the locking pins (2) with rolling sleeves (8) and snap rings (4). Screw holes (5) are indicated by dashed lines.

FIG. 1C is a side elevation of the male portion of the Door Security Locking Device showing the locking pins (2) with rolling sleeves (8) and crimp (9). Screw holes (5) are shown with dashed lines.

FIG. 3A shows the plan view of the female leaf (12) of the device showing slots or holes (11) which receive the locking pins (2) of the male portion of the device. Countersunk screw holes (5,6) are shown as concentric circles.

FIG. 3B shows the side view of the female portion (12) of the device and indicating the pin slots or holes (11) and countersunk screw holes (5,6) with dashed lines.

FIG. 2A shows a section through the locking pin roller retained by crimping (9) or snap rings and all simple mechanical means.

### SUMMARY, RAMIFICATIONS AND SCOPE

Based on the above description the examiner will see that the Door Security Locking Device is a device that can be conveniently retrofitted to existing doors to provide added security whenever required.
1. It can be produced in various configurations with one or more locking pins (2).
2. It can be produced with simple solid locking pins or complex locking pins which are fitted with rotating external sleeves or rotating internal rods.
3. It can be produced from various plastics, reinforced plastics or metals and all combinations thereof.
4. It can be retrofitted to existing doors and door frames with hand tools.
5. It can be attached to door frames and doors with two or more countersunk screws.

Although the description above contains many specifications, these should not be construed as limiting the scope of the invention but as merely providing for some of the presently preferred configurations of this invention. For example the Door Security Locking Device can be produced in a wide range of sizes and configurations and combinations of metals and plastics.

Thus the scope of the invention should be determined by the appended claims and their logical equivalents, rather than by a narrow assessment of the examples given.

I claim:

1. In a door security device of any metal or plastic and all combinations thereof consisting of two mating pieces. One of these mating pieces is attached to the door frame and the other of these mating pieces is attached to the hinged edge of the door said pieces engaging and interlocking when the door is closed.

2. The door security device of claim 1 wherein said device consists of two flat mating and interlocking pieces.

3. The door security device of claim 1 consisting of a female piece attached to the door frame and having one or more notches to receive pins protruding from the male half of the device.

4. The door security device of claim 1 wherein the male piece of the device is attached to the hinged edge of the door and being fitted with one or more pins designed to mesh with notches in the female half of the device.

5. The door security device of claim 1 wherein the male piece of the device is attached into a fitted recess in the hinged edge of the door.

6. The door security device of claim 1 wherein said pieces consists of a flat metallic plates drilled to receive two or more countersunk metallic screws to secure said piece into a fitted recesses in the door drilled to receive one or more metallic pins.

7. The door security device of claim 1 wherein said pieces consists of flat metallic plates are drilled to receive two or more countersunk metallic screws to secure said pieces into fitted recesses in the door frame at the hinged edge of the door.

8. The door security device of claim 1 wherein the male piece of the door security device is attached into a fitted recess in the hinged edge of the door.

9. The door security device of claim 1 wherein said male piece is positioned so as to mate with and interlock with the female piece of the door security device which is attached to the door frame.

10. The door security device of claim 1 wherein said male piece is drilled to receive one or more countersunk metallic screws.

11. The door security device of claim 1 wherein said male piece is fitted with one or more metallic pins.

12. The door security device of claim 1 wherein said metallic pin or pins are secured by welding to protrude through the male metallic plate.

13. The door security device of claim 1 wherein said metallic pin or pins are positioned perpendicularly through said male metal plate.

14. The door security device of claim 1 wherein said metallic pin or pins are welded or forged to said male metallic plate.

15. The door security device of claim 1 wherein said metallic pin or pins are positioned length-wise through said moveable plate to provide an equal shear resistance to the door frame and hinged edge of the door to which it is fitted when the door is in the closed and locked position.

16. The door security device of claim 1 wherein the male plate of the device is attached to the hinged edge of the door.

17. The door security device of claim 1 wherein said male plate attached to the hinged edge of the door holds one or more pins.

18. The door security device of claim 16 is fitted with cylindrical or tapered pins.

19. The door security device of claim 16 wherein the cylindrical or tapered pins are fitted with rotating sleeves.

20. The door security device of claim 18 wherein said rotating sleeves are secured to said cylindrical or tapered pins by all suitable methods including crimping into grooves or shrinking onto a shank with forged shoulders or retained with snap rings.

21. The door security device of claim 16 wherein the cylindrical or tapered pins are drilled lengthwise parallel to the central axis to receive internal rotating metal pins or rods.

22. The door security device of claim 16 wherein said internal rotating metal rods or pins are retained by crimping or snap rings and all other common mechanical methods.
